(19) United States
(12) Patent Application Publication
(10) Pub. No.: US 2024/0303765 A1
(43) Pub. Date: Sep. 12, 2024

(54) RESOURCE OPTIMIZATION FOR GRAPHICAL RENDERING

(71) Applicant: INTERNATIONAL BUSINESS MACHINES CORPORATION, ARMONK, NY (US)

(72) Inventors: Guang Han Sui, Beijing (CN); Peng Hui Jiang, Beijing (CN); Su Liu, Austin, TX (US); Jun Su, Beijing (CN); Yu Zhu, Beijing (CN)

(21) Appl. No.: 18/178,814

(22) Filed: Mar. 6, 2023

(51) Int. Cl. G06T 1/20

(52) U.S. Cl. CPC G06T 1/20; G06T 2210/61

(57) ABSTRACT

A system may receive a frame, divide the frame into objects, select an object from the objects, divide the object into regions, determine a set of attributes for a target region of the regions, assign a priority to the target region, and queue, based on an assignment of a low priority, the target region to a discount rendering instance.

### BACKGROUND

Aspects of the present disclosure relate to resource optimization for graphical rendering.

Rendering images is the process of generating an image and/or video from a 2D or 3D model by a computer program. The resulting image is referred to as the render. Multiple models can be defined in a scene file containing objects in a strictly defined language or data structure. The scene file may contain geometry, viewpoint, texture, lighting, and shading information describing the virtual scene. The data contained in the scene file is then passed to a rendering program to be processed and output to a digital image or raster graphics image file. In some instances, graphical rendering may also include the process of calculating effects in a video editing program to produce the final video output.

Rendering may be used in fields that create images and/or video from models, such as architecture, video games, simulators, movie and TV visual effects, and design visualization. A wide variety of rendering platforms are available. Rendering software may be integrated into larger modeling and animation packages or provided as a stand-alone product.

### BRIEF SUMMARY

The present disclosure provides a method, computer program product, and system of resource optimization for graphical rendering. In some embodiments, the method includes receiving a frame, dividing frame into objects, selecting an object from the objects, dividing the object into regions, determining a set of attributes for a target region of the regions, assigning a priority to the target region, and queuing, based on an assignment of a low priority, the target region into a discount rendering instance.

Some embodiments of the present disclosure can also be illustrated by a computer program product comprising a computer readable storage medium having program instructions embodied therewith, the program instructions executable by a processor to cause the processors to perform a method, the method comprising receiving a frame, dividing frame into objects, selecting an object from the objects, dividing the object into regions, determining a set of attributes for a target region of the regions, assigning a priority to the target region, and queuing, based on an assignment of a low priority, the target region into a discount rendering instance.

Some embodiments of the present disclosure can also be illustrated by a system comprising a processor and a memory in communication with the processor, the memory containing program instructions that, when executed by the processor, are configured to cause the processor to perform a method, the method comprising receiving a frame, dividing frame into objects, selecting an object from the objects, dividing the object into regions, determining a set of attributes for a target region of the regions, assigning a priority to the target region, and queuing, based on an assignment of a low priority, the target region into a discount rendering instance.

### BRIEF DESCRIPTION OF THE DRAWINGS

FIG. 1 depicts a computer system according to various embodiments of the present disclosure.

FIG. 2A depicts an example visual frame, according to various embodiments of the present disclosure.

FIG. 2B depicts example objects in a visual frame, according to various embodiments of the present disclosure.

FIG. 2C depicts example regions of objects in a visual frame, according to various embodiments of the present disclosure.

FIG. 3 illustrates an example method for resource optimization for graphical rendering, according to various embodiments of the present disclosure.

FIG. 4 illustrates one representation of a set of neural networks in a larger aggregate neural network that may prepare input data for a probability-generator neural network, in accordance with embodiments.

FIG. 5 depicts an example neural network 500 that may be specialized to process a vector or set of vectors associated with a word type (e.g., entity vectors), in accordance with embodiments.

FIG. 6 illustrates an example probability-generator neural network 600 with multiple pattern recognition pathways and multiple sets of inputs, in accordance with embodiments.

FIG. 7 illustrates a representation of a system 700 that utilizes multiple probability-generation neural networks and structured data to generate a composite projection, in accordance with embodiments.

### DETAILED DESCRIPTION

Aspects of the present disclosure relate to resource optimization for graphical rendering. While the present disclosure is not necessarily limited to such applications, various aspects of the disclosure may be appreciated through a discussion of various examples using this context.

Neural networks may be trained to recognize patterns in input data by a repeated process of propagating training data through the network, identifying output errors, and altering the network to address the output error. Training data that has been reviewed by human annotators is typically used to train neural networks. Training data is propagated through the neural network, which recognizes patterns in the training data. Those patterns may be compared to patterns identified in the training data by the human annotators in order to assess the accuracy of the neural network. Mismatches between the patterns identified by a neural network and the patterns identified by human annotators may trigger a review of the neural network architecture to determine the particular neurons in the network that contributed to the mismatch. Those particular neurons may then be updated (e.g., by updating the weights applied to the function at those neurons) in an attempt to reduce the particular neurons' contributions to the mismatch. This process is repeated until the number of neurons contributing to the pattern mismatch is slowly reduced, and eventually the output of the neural network changes as a result. If that new output matches the expected output based on the review by the human annotators, the neural network is said to have been trained on that data.

Once a neural network has been sufficiently trained on training data sets for a particular subject matter, it may be used to detect patterns in analogous sets of live data (i.e., non-training data that have not been previously reviewed by human annotators, but that are related to the same subject matter as the training data). The neural network's pattern recognition capabilities can then be used for a variety of applications. For example, a neural network that is trained on a particular subject matter may be configured to review live data for that subject matter and predict the probability that a potential future event associated with that subject matter will occur.

However, accurate event prediction for some subject matters relies on processing live data sets that contain large amounts of data that are not structured in a way that allows computers to quickly process the data and derive a target prediction (i.e., a prediction for which a probability is sought) based on the data. This “unstructured data” may include, for example, data for various objects in images. Further, achieving accurate predictions for some subject matters is difficult due to the amount of sentiment context present in unstructured data that may be relevant to a prediction. For example, the relevance of many objects for visual rendering may be based on a plethora of factors, such as distance size, shape, texture, an importance of an object, etc. as well as meta data attached to each object. Unfortunately, computer-based event prediction systems such as neural networks are not currently capable of utilizing this sentiment context in target predictions due, in part, to a difficulty in differentiating sentiment-context data that is likely to be relevant to a target prediction from sentiment-context data that is likely to be irrelevant to a target prediction. Without the ability to identify relevant sentiment-context data, the incorporation of sentiment analysis into neural-network prediction analysis may lead to severe inaccuracies. Training neural networks to overcome these inaccuracies may be impractical, or impossible, in most instances.

The amount of unstructured data that may be necessary for accurate prediction analysis may be so large for many subject matters that human reviewers are incapable of analyzing a significant percentage of the data in a reasonable amount of time. Further, in many subject matters, large amounts of unstructured data is made available frequently (e.g., daily), and thus unstructured data may lose relevance quickly. For this reason, human reviewers are not an effective means by which relevant sentiment-context data may be identified for the purposes of prediction analysis. Therefore, an event-prediction solution that is capable of analyzing large amounts of structured data, selecting the sentiment context therein that is relevant to a target prediction, and incorporating that sentiment context into a prediction is required.

Some embodiments of the present disclosure may improve upon neural-network predictive modeling by incorporating multiple specialized neural networks into a larger neural network that, in aggregate, is capable of analyzing large amounts of structured data, unstructured data, and sentiment context. In some embodiments one component neural network may be trained to analyze sentiment of unstructured data that is related to the target prediction, whereas another component neural network may be designed to identify lists of words that may relate to the target prediction. As used herein, the terms “word” and “words” in connection with, for example, a “word type,” a “word list,” a “word vector,” an “identified word” or others may refer to a singular word (e.g., “Minneapolis”) or a phrase (e.g., “the most populous state in Minnesota”). For this reason, a “word” as used herein in connection with the examples of the previous paragraph may be interpreted as a “token.” In some embodiments, this list of relevant words (e.g., entities) may be cross-referenced with sentiment-context data that is also derived from the unstructured data in order to identify the sentiment-context data that is relevant to the target prediction. In some embodiments, the multiple neural networks may operate simultaneously, whereas in other embodiments the output of one or more neural networks may be received as inputs to another neural network, and therefore some neural networks may operate as precursors to another. In some embodiments, multiple target predictions may be determined by the overall neural network and combined with structured data in order to predict the likelihood of a value at a range of confidence levels. In some embodiments these neural networks may be any type of neural network. For example, “neural network” may refer to a classifier-type neural network, which may predict the outcome of a variable that has two or more classes (e.g., pass/fail, positive/negative/neutral, or complementary probabilities (e.g., 60% pass, 40% fail)). “Neural network” may also refer to a regression-type neural network, which may have a single output in the form, for example, of a numerical value.

In some embodiments, for example, a neural network in accordance with the present disclosure may be configured to generate a prediction of the probability of a target event (i.e., the event for which a probability is sought in a target prediction) related to a particular subject matter. This configuration may comprise organizing the component neural networks to feed into one another and training the component neural networks to process data related to the subject matter. In embodiments in which the output of one neural network may be used as the input to a second neural network, the transfer of data from the output of one neural network to the input of another may occur automatically, without user intervention.

For example, in some embodiments a predictive neural network may be utilized to predict the numerical probability that a particular publicly traded company may realize a profit in a given fiscal quarter. The predictive neural network may be composed of multiple component neural networks that are complementarily specialized. For example, a first component neural network may be specialized in analyzing unstructured data related to the company (e.g., newspaper articles, blog posts, and financial-analyst editorials) to identify a list of entities in the unstructured data and identify sentiment data for each of those entities. One such entity, for example, may be the name of the particular company, whereas another such entity may be the name of the particular company's CEO.

However, the list of entities and corresponding sentiment data may also contain irrelevant entities (and thus sentiment data). For example, one object may have details on an interior surface of an object that a viewer does not see. Therefore, a second component neural network may be specialized to review structured and unstructured data and identify a list of relevant entities within the unstructured data. This list of entities may then be cross-referenced with the entities identified by the first component neural network. The sentiment data of the entities identified as relevant by the second component neural network may then be selected.

In this example, the list of entities identified by the second component neural network may be vectorized by a third component neural network. As a result, each entity from the list of entities may be represented by a corresponding word vector, and each feature vector may be associated with corresponding sentiment data. These word vectors and associated sentiment data may be input into a fourth component neural network. This fourth component neural network may be specialized to process the word vectors and sentiment data and output a numerical probability that the particular object needs to be rendered.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as example method 300 for resource optimization for graphical rendering. In addition to block 300, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 300, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

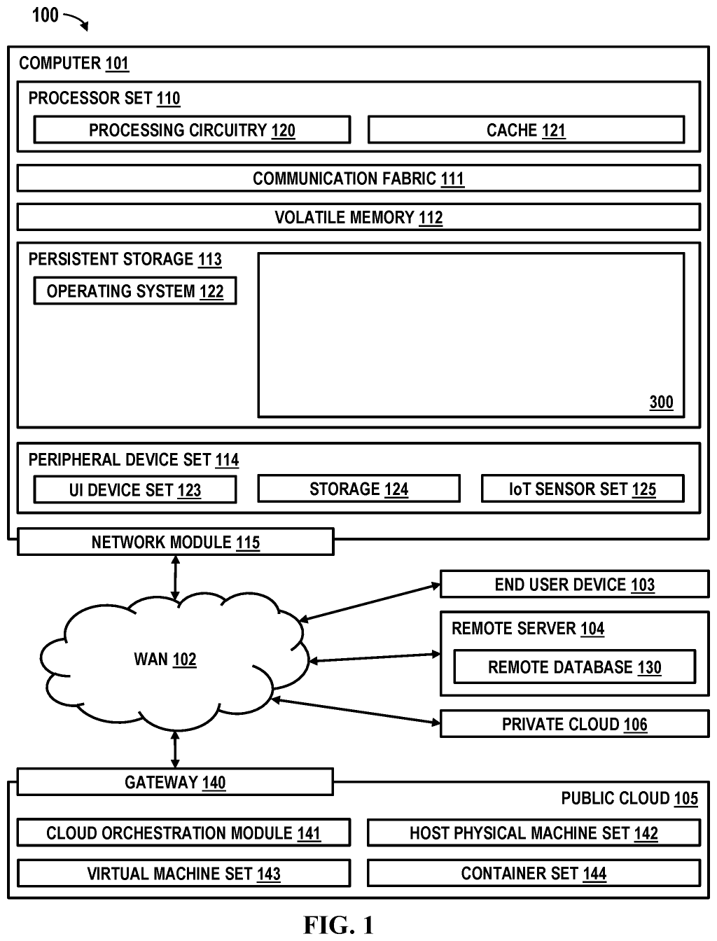

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 300 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 300 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Graphical rendering is often a resource intensive process that may overburden many systems. Discount processing (for example, rendering) services exist, but they are unreliable and may not produce renderings in time for use in a system. Therefore, in some embodiments, a system is proposed to schedule a portion of a frame with a discount processing service, thereby enhancing the performance of the system by relieving the burden on normal rendering process.

In some embodiments, to effectively schedule low priority portions of a frame, objects defined by a model are extracted from a frame and split into regions. The regions may be prioritized and sent to a discount rendering instance or a normal rendering instance depending on the prioritization.

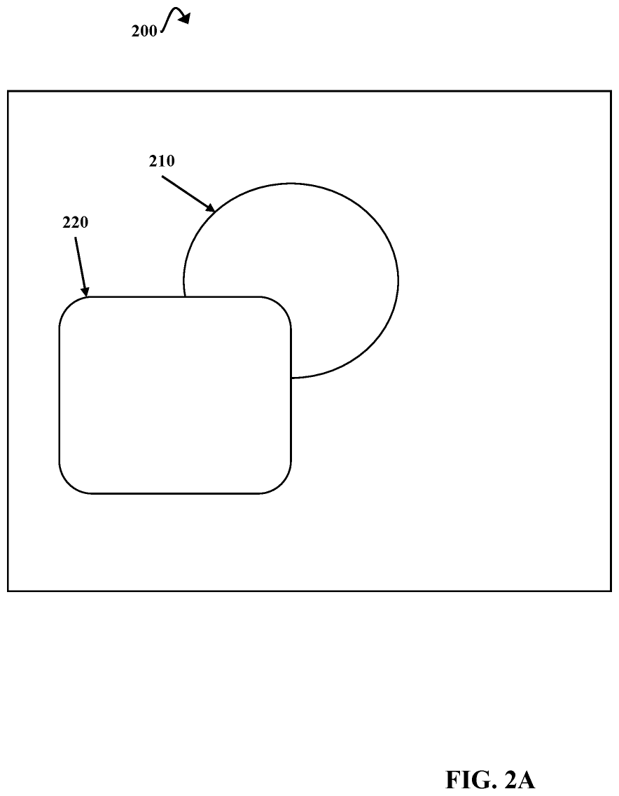

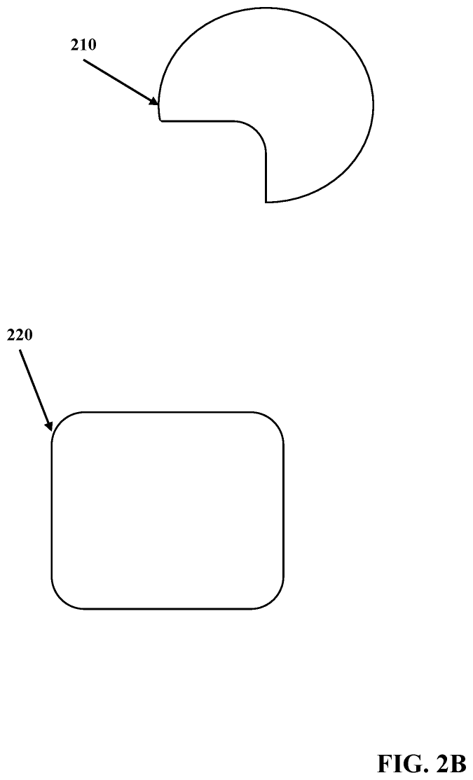

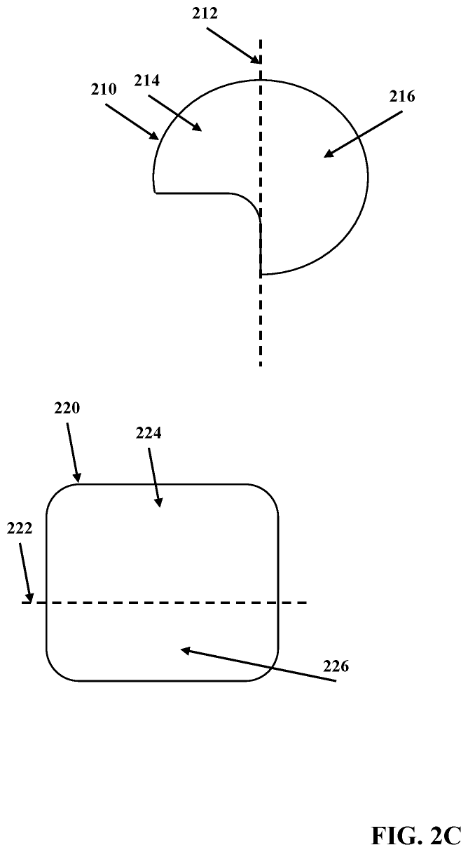

FIG. 2A Depicts a visual frame 200 with two objects: a circle 210 and a rectangle 220, that may be rendered for display. In some instances, one object may obscure another object. For example, rectangle 220 partially obscures circle 210. In some instances, a frame is a single image in a sequence of pictures. For example, one second of a video may be comprised of 24 or 20 frames per second (also known as FPS). The frame is a combination of the image and the time of the image when exposed to the viewer. For 3D images, a different frame may be required for each eye to produce a 3D effect. Objects are shown for simple examples, real objects may be more complex than those depicted if FIG. 2A-2C. For example, rendered objects may be a door, a brick wall, a brick in the wall, a section of grass, an animal, an avatar, etc. Avatar herein refers to a user's character or perspective in a virtual environment.

FIG. 2B depicts circle 210 and rectangle 220 from FIG. 2A as they would individually be rendered. For example, the portion of circle 210 that is obscured would not need to be rendered because it will not be visible to a user. An example of a more complex object, not depicted, may be a wooden crate in front of a brick wall. In this example, the bricks that are partially covered by the wooden crate may not need to be fully rendered.

FIG. 2C depicts an example of how objects may be separated into regions. For example, circle 210 is divided by line 212 to create region 214 and 216, and rectangle 220 is divided by line 222 to create region 224 and 226. In a more complex example, not depicted, a door may be split into sections to divide the door into separate regions so each region may be rendered individually. In another example, a brick wall may be rendered into regions of one or more bricks. The regions in this example may follow the brick lines or be divided by area (e.g., 1′×1′ sections).

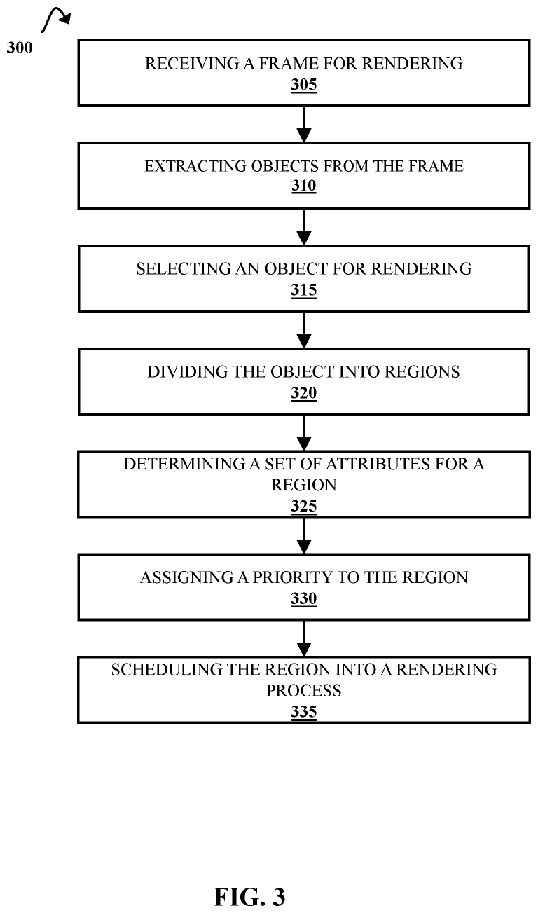

FIG. 3 depicts an example method 300 for resource optimization for graphical rendering. Operations of method 300 may be enacted by one or more computer systems such as the system described in FIG. 1 above.

Method 300 begins with operation 305 of receiving a frame for rendering. For example, a virtual reality system may determine what images need to be displayed for a user and send those to be rendered.

Method 300 continues with operation 310 of extracting one or more objects from the frame. For example, where an avatar is approaching a cottage and the sightline of the avatar, the system may extract the grass in front of the cottage, the grass behind the cottage, the sky behind the cottage, the wall of the cottage, the path to the cottage, the roof of the cottage, and the door of the cottage.

Method 300 continues with operation 315 of selecting an object for rendering. In some embodiments, not all objects may need to be rendered. Following the example from above, the system may determine that the grass behind the cottage does not need to be rendered because the viewer/avatar would not be able to see the grass behind the cottage. Conversely, the system may determine that the grass in front of the cottage, the sky behind the cottage, the wall of the cottage, the path to the cottage, the roof of the cottage, and the door of the cottage may need to be at least partially displayed. In some embodiments, a 3D model may have elements that do not need to be fully displayed. For example, the grass in front of the cottage may extend under the cottage in the 3D model, but only the grass in front of the cottage would need to be displayed and therefor rendered, whereas the grass under the cottage would not need to be rendered.

Method 300 continues with operation 320 of dividing the objects into regions. For example, the system may divide the brick wall into 1′×1′ segments and divide the door into two regions.

Method 300 continues with operation 325 of determining a set of attributes for a region. In some instances, the attributes of a region may be importance, rendering time, due time, and backup region. Importance may be an assigned value such as high or low, a ranking in comparison to the other frames, or a percentage (such as 92% importance or 34% importance). In some embodiments, importance may be defined by the application that is providing the graphics. For example, a game may put a low importance on a background wall, a low importance on characters the avatar is not engaged with and a high importance to a character that the avatar is speaking with. In some embodiments, importance may depend on a user's interaction and proximity. For example, a region that a user can see and take actions in (e.g., a door that may be opened by the user) is high importance, a region that the user can see and has no actions with but is near the user (e.g., a wall of a building near the user) is medium importance, and a region that is far away from user where the user can see and no has no actions with (e.g., a wall of a building far away from the user) is low importance. Attributes may be set by the virtual environment, the user, or another party that has the privileges to do so. In some embodiments, the system may place a high importance on specific items. For example, a high importance may be assigned to a unique item (such as a storyline item), an item the avatar is focused on, or an item in an avatar's hand. In some embodiments, a priority of an object is a received value, and an importance is a determination made by the system and used to determine how an object is rendered.

In some instances, rendering time is the duration (or processing power) it takes to render a region. For example, processing a region may take 3 minutes with a first processor. Rendering time may depend on the power of a processor. In some instances, due time is the time that rendering need to be finished for use. For example, most regions need to be finished rendering before they are displayed. In some instances, a backup region is an analogous or similar region where the rendering of the similar region may be used if the rendering of the main region is not displayed. For example, if a target region (e.g., brick) cannot be rendered on time, a rendering of a similar region (e.g., another brick) may be used to fill the target rendering as a workaround.

Method 300 continues with operation 330 of dynamically assigning a priority to the region. In some embodiments, based on the attributes the system may assign a priority for a region. For example, all regions of high importance due within a certain time period may be assigned a high priority, whereas regions with a low importance and a small (e.g., short) rendering time may be assigned a low priority. In some embodiments, priority assignment schemes may be determined by the system or the application being run by the system. In some embodiments, the system may use machine learning to train a neural network to assign a priority to a region. For example, the system may receive a set of data for previously assigned regions, train the neural network to assign priority (as described herein), and deploy the trained neural network on a new region to assign a priority. As described, the neural network may use factors such as importance of an object/region, distance of the region to the viewer, and placement of the region in an avatar's sight line, among others, to assign a priority.

Method 300 continues with operation 335 of scheduling or queueing the region into a rendering process. In some embodiments, based on an assignment of low priority, the region may be assigned to a discount rendering. In some instances, discount rendering may be a type of processing resource that is run when a discount service system is free (e.g., using spare processing power, unused processing capacity, or off-peak processing resources). Discount rendering may be ⅕˜ 1/10 the cost of normal, on-demand resources. A discount instance is an instance that is available for less than the on-demand price (e.g., because it uses such spare computing capacity). Because discount instances enable a system to request unused computing instances at steep discounts, the overall computing costs may be reduced significantly. The hourly price for a discount instance may be adjusted based on the long-term supply of and demand for discount instances. In some instances, discount instances run whenever capacity is available.

In some instances, frame rendering requests are scheduled to discount instances and normal instances (e.g., on demand instances) by a scheduling policy. The “discount instances” are the less expensive interruptible instances, and the “normal instances” are the stable instances (since on-demand rendering is unlikely to fail) that are scheduled into a normal process. In some embodiments, a target number of regions may be scheduled for discount rendering. For example, a system may designate 50% of regions in a frame for discount rendering. In some embodiments, the low priority regions will be scheduled first to the discount instances, then the regions with medium priority until the target number of instances is reached. This allows the system to streamline performance and increase processing speed by focusing on key elements of the image. By identifying and managing low importance areas first, the system may focus key resources on critical areas and reduce overall processing time. If one region is interrupted during a discount rendering instance, the discount rendering may be resubmitted (e.g., re-tried), the backup rendered region may be used as the result, or a default rendered result will be used (e.g., use gray on that region). In some embodiments, one region with low/medium priority may be sent to several discount instances to increase the likelihood that one of them produces a result. For example, if a region does not have a backup, it may be more critical that a rendering is received. Multiple discount instances may still produce a cost savings over one normal instance. In some instances, discount instances may improve the function and speed of the computer when rendering is not needed immediately and when the rendering may be interrupted. For example, discount rendering is useful where rendering of a region may be replaced with a backup or does not need to be rendered quickly.

In some embodiments, based on an assignment of a high priority, the region may be assigned to a priority rendering. In some instances, priority rendering may be rendering by a dedicated system on a device (e.g., virtual reality system) or an on-demand service (e.g., an instance of rendering by a service.

In some embodiments, the regions with high priority can also be scheduled to the discount instances when there is sufficient time to retry them on normal instances if the rendering failed on discount instances. In some instances, the “due time” and “rendering time” can help to make the decision on whether or not to process a high priority region as a discount instance. For example, if there would be enough time to render a region with a normal instance after a failure on a discount instance (e.g., a relatively long due time), the system may first send the region to a discount instance.

In some embodiments, regions from different users may be mixed to render on one discount instance. For example, where a discount instance may have room to render 10 different frames, a scheduler may assign the discount instance a region from 10 different users. In some instances, assigning different user's renderings to a single discount instance reduces the impact of an interrupted instance on any single user, instead is spreading the burden to multiple users. The spreading of the burden improves processing by any individual user by decreasing the drain on the system.

In some embodiments, the scheduling policy may be changed dynamically based on the frame rendering results from previous rendering iterations. For example, if the discount instances have not been stable, and therefore, the frame rendering success probability is lower than configured threshold (e.g., 90%), one frame rendering request can be scheduled to two or more instances to ensure the threshold is met.

In some instances, where the cost on discount instances is higher than normal instances (e.g., frame rendering requests cannot succeed on discount instances), the system may use normal instances instead of discount instances. For example, if the frame rendering success is below a threshold, the system may use a normal instance instead of a discount instance. In some embodiments, when a discount region fails a rendering more than a threshold number of times, the system may upgrade the region to a normal rendering for the next rendering.

Artificial neural networks (ANNs) can be computing systems modeled after the biological neural networks found in animal brains. Such systems learn (i.e., progressively improve performance) to do tasks by considering examples, generally without task-specific programming. For example, in image recognition, ANNs might learn to identify images that contain cats by analyzing example images that have been manually labeled as “cat” or “no cat” and using the analytic results to identify cats in other images.

In some embodiments of the present disclosure, neural networks may be used to recognize new sources of knowledge. Neural networks may be trained to recognize patterns in input data by a repeated process of propagating training data through the network, identifying output errors, and altering the network to address the output error. Training data may be propagated through the neural network, which recognizes patterns in the training data. Those patterns may be compared to patterns identified in the training data by the human annotators in order to assess the accuracy of the neural network. In some embodiments, mismatches between the patterns identified by a neural network and the patterns identified by human annotators may trigger a review of the neural network architecture to determine the particular neurons in the network that contribute to the mismatch. Those particular neurons may then be updated (e.g., by updating the weights applied to the function at those neurons) in an attempt to reduce the particular neurons' contributions to the mismatch. In some embodiments, random changes are made to update the neurons. This process may be repeated until the number of neurons contributing to the pattern mismatch is slowly reduced, and eventually, the output of the neural network changes as a result. If that new output matches the expected output based on the review by the human annotators, the neural network is said to have been trained on that data.

In some embodiments, once a neural network has been sufficiently trained on training data sets for a particular subject matter, it may be used to detect patterns in analogous sets of live data (i.e., non-training data that has not been previously reviewed by human annotators, but that are related to the same subject matter as the training data). The neural network's pattern recognition capabilities can then be used for a variety of applications. For example, a neural network that is trained on a particular subject matter may be configured to review live data for that subject matter and predict the probability that a potential future event associated with that subject matter may occur.

In some embodiments, a multilayer perceptron (MLP) is a class of feedforward artificial neural networks. An MLP consists of, at least, three layers of nodes: an input layer, a hidden layer, and an output layer. Except for the input nodes, each node is a neuron that uses a nonlinear activation function. MLP utilizes a supervised learning technique called backpropagation for training. Its multiple layers and non-linear activation distinguish MLP from a linear perceptron. It can distinguish data that is not linearly separable. Also, MLP can be applied to perform regression operations.

However, accurate event prediction for is not possible with traditional neural networks since terms are not listed in ground truth repositories. For example, if a manufacturer of a device has not been previously identified, the neural network may not be able to identify such a manufacturer.

The amount of data that may be necessary for accurate prediction analysis may be sufficiently large for many subject matters that analyzing the data in a reasonable amount of time may be challenging. Further, in many subject matters, large amounts of data may be made available frequently (e.g., daily), and thus data may lose relevance quickly.

In some embodiments, multiple target predictions may be determined by the overall neural network and combined with structured data in order to predict the likelihood of a value at a range of confidence levels. In some embodiments, these neural networks may be any type of neural network. For example, “neural network” may refer to a classifier-type neural network, which may predict the outcome of a variable that has two or more classes (e.g., pass/fail, positive/negative/neutral, or complementary probabilities (e.g., 60% pass, 40% fail)). For example, pass may denote “no maintenance/service needed” and fail may denote “maintenance/service needed.” “Neural network” may also refer to a regression-type neural network, which may have a single output in the form, for example, of a numerical value.

In some embodiments, for example, a neural network in accordance with the present disclosure may be configured to generate a prediction of the probability of a detected network device. This configuration may comprise organizing the component neural networks to feed into one another and training the component neural networks to process data related to the subject matter. In embodiments in which the output of one neural network may be used as the input to a second neural network, the transfer of data from the output of one neural network to the input of another may occur automatically, without user intervention.

As discussed in herein, in some embodiments of the present invention, an aggregate predictor neural network may comprise specialized neural networks that are trained to prepare unstructured and structured data for a new knowledge detection neural network. In some embodiments different data types may require different neural networks, or groups of neural networks, to be prepared for detection of terms.

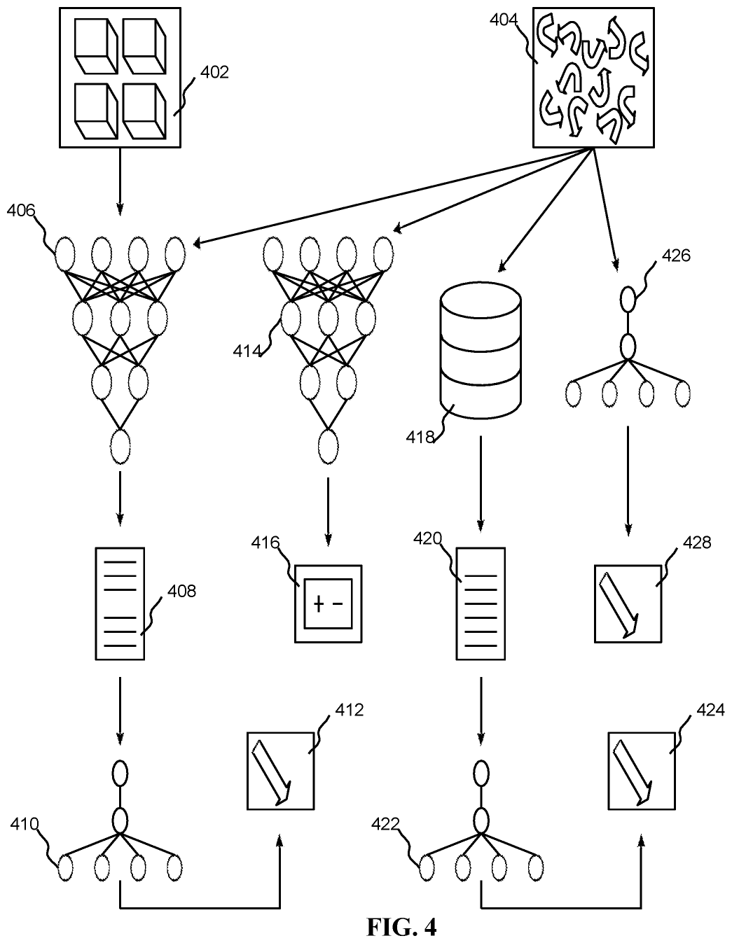

FIG. 4 illustrates one representation of a set of neural networks in a larger aggregate neural network that may prepare input data for a new knowledge detection neural network. Structured data 402 and unstructured data 404 represent the base inputs to the neural network. Structured data 402 and unstructured data 404 are inputs into neural network 406, which may be trained in the terms (e.g., vocabulary) of the subject matter to which the structured data 402 and unstructured data 404 pertains. Neural network 406 may also be trained to recognize patterns in the structured data 402 and unstructured data 404, and identify a word list based on those patterns. For example, in some embodiments neural network 406 may comprise an entity model that identifies a list of entities 408 within the unstructured data 404 that may be relevant to a target prediction. In other embodiments, however, other types of word lists are possible.

The list of entities 408 is input into neural network 410. Neural network 410 may be specialized to process the list of entities 408 and output at least one feature vector 412. In some embodiments, feature vector 412 may be a numerical feature vector. In some embodiments, for example, neural network 410 may analyze the unstructured data and determine the contextual relationship of each entity in the list of entities 408 to the remainder of the structured data. Neural network 410 may then assign numerical values to the corresponding word vectors of those entities such that entities with close contextual relationships are situated in close proximity in a vector space. Thus, in some embodiments, feature vector 412 may contextually describe an entity based on the perceived relationships of the entity to the other words used in structured data 404. In some embodiments, feature vector 412 may actually represent multiple feature vectors (e.g., one vector for each entity in the list of entities 408). In other embodiments, only one vector may be produced.

Unstructured data 404 is also input into neural network 414, which may be a sentiment classifier neural network. Neural network 414 may process the unstructured data to identify words used throughout the unstructured data to which sentimental context may be ascribed. In some embodiments, this processing may involve tokenizing the unstructured data (i.e., dividing the data into small sections, such as words, that may be easily identified and processed).

Neural network 414 may output sentiment score 416. Sentiment score 416 may take the form of a value within a predetermined range of values (e.g., 1.0 to −1.0) that measures the type of sentiment and magnitude of sentiment associated with a word in a word list identified from within structural data 404. For example, sentiment score 416 may be the sentiment in structured data 404 that is associated with an entity in the list of entities 408. In some embodiments, list of entities 408 may cross-referenced with the output of neural network 414 to identify relevant sentiment scores. In some embodiments, neural network 414 may also output an average sentiment score of the entire structured data 404. This average sentiment score may also be utilized in prediction analysis.

Unstructured data 404 is also input to concept mapper 418. Concept mapper 418 may comprise a database of entities and semantic “facts” about those entities. Those semantic “facts” may include a list of higher-level concepts associated with the entities in the database. Concept mapper 418 may ingest unstructured data 404 and map the words found therein to a list of concepts associated with those entities. In some embodiments, this may include tokenizing the unstructured data and detecting words found in the tokens that are also found in the database of entities. The concepts that are associated with those words may then be determined based on the relationships in the database, and output as concept list 420.

In some embodiments, entity list 408 may also be input into 418 with, or instead of, unstructured data 404. In those embodiments, concept mapper 418 may match the entities found in entity list 408 with entities found in the database associated with concept mapper 418. Concept associations may be identified for any entities that are also found within the database. The concepts identified by those associations may then be output to concept list 420.

In some embodiments, concept list 420 may also be input into neural network 414 with unstructured data 404. Neural network 414 may then determine a sentiment score 416 for at least one concept in the list of concepts 420. This sentiment score may reflect the sentiment associated with the at least one concept in the unstructured data 404. In some embodiments a separate sentiment score 416 may be determined for each concept in list of concepts 420.

The list of concepts 420 is input into neural network 422. In some embodiments, neural network 422 may be a distinct neural network from neural network 410. In other embodiments neural networks 410 and 422 may be the same network. Neural network 422 may be specialized to process the list of concepts 420 and output at least one feature vector 424. In some embodiments, feature vector 424 may be a numerical feature vector. In some embodiments, feature vector 412 may contextually describe a concept based on the perceived relationships of the concept to the other words used in structured data 404. In some embodiments, feature vector 424 may actually represent multiple feature vectors (e.g., one vector for each concept in the list of concepts 420). In other embodiments, only one vector may be produced.

Unstructured data 404 may also be input into neural network 426. In some embodiments, neural network 426 may be a distinct neural network from neural network 410 and neural network 422. In other embodiments neural networks 410, 422, and 426 may all be the same network. Neural network 426 may be specialized in processing the unstructured data an identifying words that, based on their usage or contextual relationships, may be relevant to a target prediction (referred to herein as “keywords”). Neural network 426 may, for example, select keywords based on the frequency of use within the unstructured data 404. Neural network may then vectorize the selected keywords into at least one feature vector 428.

Neural network 426 may also vectorize the words in unstructured data 404, embedding the vectorized words into a vector space. The vector properties may be created such that the vectors of contextually similar words (based on the usage in unstructured data 404) are located are located in closer proximity in that vector space than vectors of contextually dissimilar words. Neural network 426 may then select word vectors based on the proximity of those word vectors to other word vectors. Selecting word vectors that are located near many other word vectors in the vector space increases the likelihood that those word vectors share contextual relationships with many other words in unstructured data 404, and are thus likely to be relevant to a target prediction. The words embedded in these word vectors may represent “keywords” of the unstructured data 404.

The word vectors produced and selected by neural network 426 may be output as at least one feature vector 428. In some embodiments, feature vector 428 may be a numerical feature vector. In some embodiments, feature vector 428 may contextually describe a keyword based on the perceived relationships of the keyword to the other words used in unstructured data 404. In some embodiments, multiple feature vectors 428 may be output by neural network 426. For example, neural network 426 may be specialized to vectorize and output as feature vectors the 500 words that are used the most frequently in unstructured data 404. In other embodiments, neural network 426 may be specialized to output the 500 feature vectors that have the closest distances to at least a threshold amount of other feature vectors in the vector space.

In some embodiments, the keyword or keywords embedded in feature vector 428 or feature vectors 426 may be input into neural network 414 with unstructured data 404. Neural network 414 may then determine a sentiment score 416 for at least one keyword. This sentiment score may reflect the sentiment associated with the at least one keyword in the unstructured data 404. In some embodiments a separate sentiment score 416 may be determined for each identified keyword.

In some embodiments, a neural network may utilize some or all of the outputs of neural networks 410, 414, 422, and 426 to predict the probability of a target event occurring. The neural network may be specialized to process a vector or set of vectors into which a word type (e.g., an entity, a concept, or a keyword) has been embedded. The neural network may also be specialized to process a sentiment score for at least one word in associated with at least one vector. The neural network may output a predicted probability that the target event will occur.

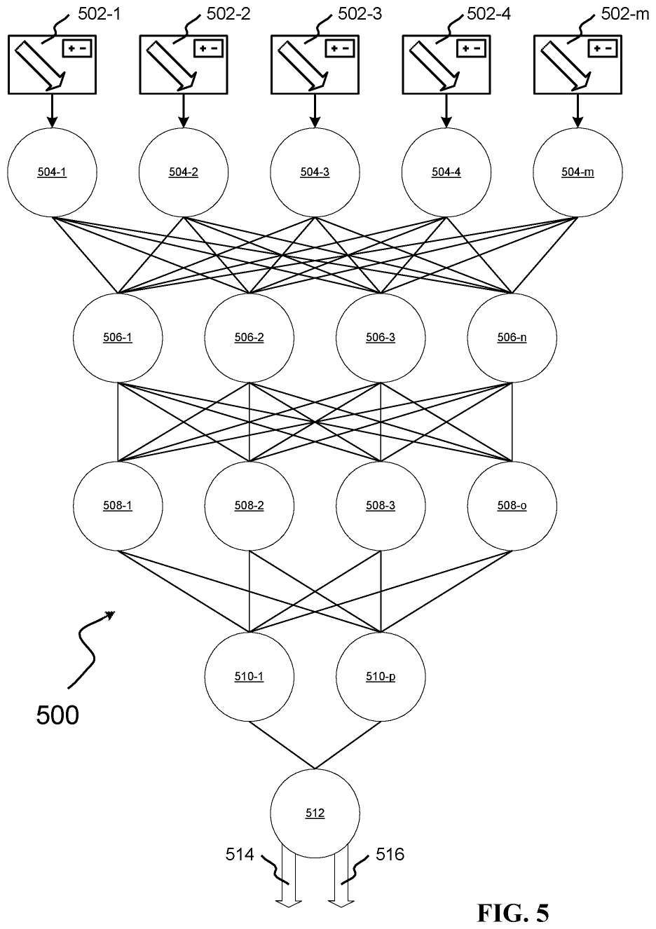

FIG. 5 depicts an example neural network 500 that may be specialized to process a vector or set of vectors associated with a word type (e.g., entity vectors). The neural network 500 may also be specialized to process at least one sentiment score associated with a word embedded within a vector. For example, neural network 500 may be specialized to process one or more outputs of the one or more neural networks disclosed in FIG. 4. In some embodiments, for example, neural network 500 may be specialized to process feature vector 412 (or multiple feature vectors 412) and sentiment score 416 (or multiple sentiment scores 416) of FIG. 4. In other embodiments, neural network 500 may be specialized to process, for example, feature vector 428 (or multiple feature vectors 428) from FIG. 4.

Neural network 500 may be a classifier-type neural network. Neural network 500 may be part of a larger neural network. For example, neural network 500 may be nested within a single, larger neural network, connected to several other neural networks, or connected to several other neural networks as part of an overall aggregate neural network.

Inputs 502-1 through 502-m represent the inputs to neural network 500. In this embodiment, 502-1 through 502-m do not represent different inputs. Rather, 502-1 through 502-m represent the same input that is sent to each first-layer neuron (neurons 504-1 through 504-m) in neural network 500. In some embodiments, the number of inputs 502-1 through 502-m (i.e., the number represented by m) may equal (and thus be determined by) the number of first-layer neurons in the network. In other embodiments, neural network 500 may incorporate 1 or more bias neurons in the first layer, in which case the number of inputs 502-1 through 502-m may equal the number of first-layer neurons in the network minus the number of first-layer bias neurons. In some embodiments, a single input (e.g., input 502-1) may be input into the neural network. In such an embodiment, the first layer of the neural network may comprise a single neuron, which may propagate the input to the second layer of neurons.

Inputs 502-1 through 502-m may comprise a single feature vector that contextually describes a word from a set of unstructured data (e.g., a corpus of natural language sources) and a sentiment score that is associated with the word described by the feature vector. For example, an object may have metadata associate with an item labeling it as quest item, in sight line, hidden, etc. Inputs 502-1 through 502-m may also comprise a plurality of vectors and associated sentiment scores. For example, inputs 502-1 through 502-m may comprise 100 word vectors that describe 100 entities and 100 sentiment scores that measure the sentiment associated with the 100 entities that the 100 word vectors describe. In other embodiments, not all word vectors input into neural network 500 may be associated with a sentiment score. For example, in some embodiments, 30 word vectors may be input into neural network 500, but only 10 sentiment scores (associated with 10 words described by 10 of the 30 word vectors) may be input into neural network 500.

Neural network 500 comprises 5 layers of neurons (referred to as layers 504, 506, 508, 510, and 512, respectively corresponding to illustrated nodes 504-1 to 504-m, nodes 506-1 to 506-n, nodes 508-1 to 508-0, nodes 510-1 to 510-p, and node 512). In some embodiments, neural network 500 may have more than 5 layers or fewer than 5 layers. These 5 layers may each comprise the same amount of neurons as any other layer, more neurons than any other layer, fewer neurons than any other layer, or more neurons than some layers and fewer neurons than other layers. In this embodiment, layer 512 is treated as the output layer. Layer 512 outputs a probability that a target event will occur, and contains only one neuron (neuron 512). In other embodiments, layer 512 may contain more than 1 neuron. In this illustration no bias neurons are shown in neural network 500. However, in some embodiments each layer in neural network 500 may contain one or more bias neurons.

Layers 504-512 may each comprise an activation function. The activation function utilized may be, for example, a rectified linear unit (ReLU) function, a SoftPlus function, a Soft step function, or others. Each layer may use the same activation function, but may also transform the input or output of the layer independently of or dependent upon the ReLU function. For example, layer 504 may be a “dropout” layer, which may process the input of the previous layer (here, the inputs) with some neurons removed from processing. This may help to average the data, and can prevent overspecialization of a neural network to one set of data or several sets of similar data. Dropout layers may also help to prepare the data for “dense” layers. Layer 506, for example, may be a dense layer. In this example, the dense layer may process and reduce the dimensions of the feature vector (i.e., the vector portion of inputs 502-1 through 502-m) to eliminate data that is not contributing to the prediction. As a further example, layer 508 may be a “batch normalization” layer. Batch normalization may be used to normalize the outputs of the batch-normalization layer to accelerate learning in the neural network. Layer 510 may be any of a dropout, hidden, or batch-normalization layer. Note that these layers are examples. In other embodiments, any of layers 504 through 510 may be any of dropout, hidden, or batch-normalization layers. This is also true in embodiments with more layers than are illustrated here, or fewer layers.

Layer 512 is the output layer. In this embodiment, neuron 512 produces outputs 514 and 516. Outputs 514 and 516 represent complementary probabilities that a target event will or will not occur. For example, output 514 may represent the probability that a target device is in a network, and output 516 may represent the probability that a target device is not in the network. In some embodiments, outputs 514 and 516 may each be between 0.0 and 1.0, and may add up to 1.0. In such embodiments, a probability of 1.0 may represent a projected absolute certainty (e.g., if output 514 were 1.0, the projected chance that the target device is in the network occur would be 100%, whereas if output 516 were 1.0, the projected chance that the target device is not in the network would be 100%).

FIG. 5 illustrates an example new knowledge detection neural network with one pattern-recognizer pathway (i.e., a pathway of neurons that processes one set of inputs and analyzes those inputs based on recognized patterns, and produces one set of outputs. However, some embodiments may incorporate a new knowledge detection neural network that may comprise multiple pattern-recognizer pathways and multiple sets of inputs. In some of these embodiments, the multiple pattern-recognizer pathways may be separate throughout the first several layers of neurons, but may merge with another pattern-recognizer pathway after several layers. In such embodiments, the multiple inputs may merge as well (e.g., several smaller vectors may merge to create one vector). This merger may increase the ability to identify correlations in the patterns identified among different inputs, as well as eliminate data that does not appear to be relevant.

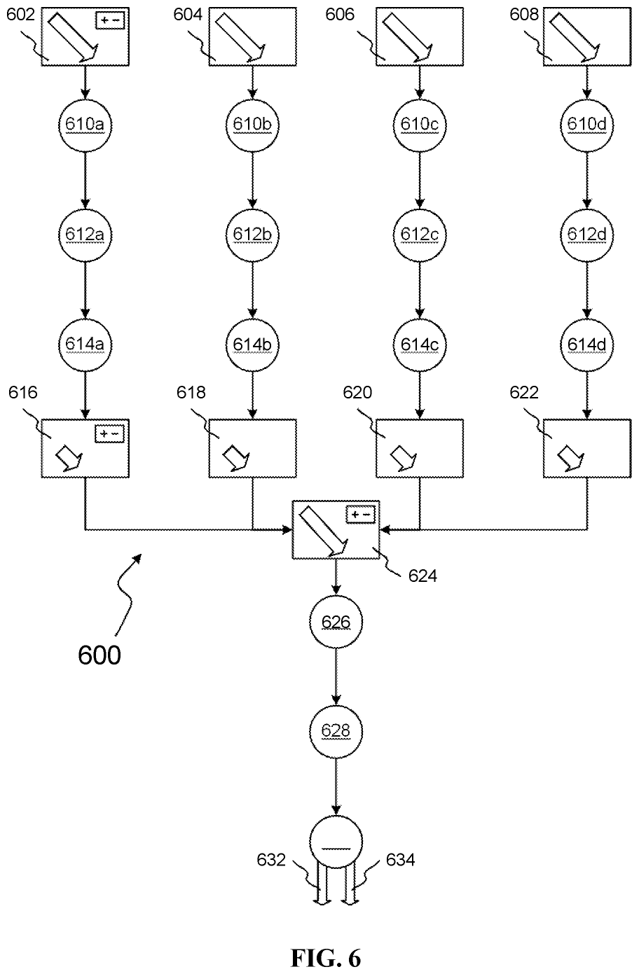

FIG. 6 illustrates an example new knowledge detection neural network 600 with multiple pattern recognition pathways and multiple sets of inputs. For example, inputs 602, combined with layers 610a-614a may represent the first several layers of a pattern-recognizer pathway similar to pattern-recognizer pathway 500 of FIG. 5. For example, input 602 may comprise an entity feature vector or multiple entity vectors and at least one sentiment score for at least one corresponding entity. Input 604 may comprise one or more concept feature vectors and input 606 may comprise one or more keyword feature vectors. Input 608 may be, for example, a sentiment feature vector. The sentiment feature vector may, for example, be composed of sentiment scores for a plurality of entities, keywords, and concepts across a corpus of natural-language sources, embedded into a vector form. For example, a sentiment vector may provide sentiment context for each entity in a group of entities. A sentiment vector may also provide an average sentiment context over a group of keywords. In some embodiments, each feature vector in inputs 602 through 608 may be the same length (e.g., 50 dimensions). In other embodiments each feature vector may have a unique length.

Neural network 600 contains, through the first several layers, four pathways. Several pathway layers (i.e., group of neurons that make up the layer in the pathway) are presented for each pathway. For example, the pathway corresponding to input 602 has three layers shown: 610a, 612a, and 614a. Layer 610a may consist of, for example, 5 neurons that are unique to layer 610a. Layers 610b, 610c, and 610d, of the pathways corresponding to inputs 604, 606, and 608 respectively, may contain 5 corresponding neurons. In other words, the 610 layer of each pathway may contain the same neurons with the same activation function. However, weights distributed among those neurons may differ among the pathways, as may the presence and properties of bias neurons. This may also be true of the 612 layer and 614 layer of each pathway. Each of layers 610a-610d, 612a-612d, and 614a-614d may be a dropout layer, a hidden layer, and a batch-normalization layer. In some embodiments each pathway may have several more layers than are illustrated. For example, in some embodiments each pathway may consist of 8 layers. In other embodiments, the non-input and non-output layers may be in multiples of three. In these embodiments, there may be an equal number of dropout, hidden, and batch normalization layers between the input and output layers.

The outputs of layers 614a-614d are outputs 616-622 respectively. Outputs 616-622 represent the inputs 602-608, however the respective feature vectors have been shortened (i.e., the dimensions of the vectors have been reduced). This reduction may occur, in each pathway, at the hidden layers. The reduction in vector dimensions may vary based on implementation. For example, in some embodiments the vectors in outputs 616-622 may be approximately 50% the length of the vectors in inputs 602-608. In other embodiments, the outputs may be approximately 45% of the length of the inputs. In some embodiments, the length of the output vectors may be determined by the number of hidden layers in the associated pathways and the extent of the vector-length reduction at each hidden layer.

Outputs 616-622 are be combined into a single input/output 624, which may comprise a single vector representing the vectors from outputs 616-622 and the sentiment score obtained from output 616. At this point, all four pathways in the network merge to a single pattern-recognition pathway. This merger may increase the ability to correlate evidence found in each pathway up to this point (e.g., to determine whether patterns being recognized in one pathway are also being recognized in others). This correlation, in turn, may enable the elimination of false-positive patterns and increase the network's ability to identify additional patterns among the merged data. Layer 626 of that pathway may comprise any number of neurons, which may provide inputs for the neurons of layer 628. These layers may provide inputs for the neurons at layer 630, which is the output layer for the network. In some embodiments, layer 630 may consist of a single output neuron. Layer 630 generates two probabilities, represented by output 632 and output 634. Output 632 may be the predicted probability that a target is in the network, and output 634 may be the predicted probability that a target device is not in the network. In this illustration two layers are presented between input/output 624 and output layer 630. However, in some illustrations more or fewer layers may be present after the pathway merge.

Some embodiments of the present disclosure may obtain a composite projection associated with a subject matter based on several neural-network projections for target events associated with the subject matter and other projections available within structured data. In such embodiments, the probabilities of several related or unrelated potential future events may be projected and combined with structured data. A processor configured to perform large-scale multiple regression analysis may combine the projected probabilities with structure data to determine a composite projection.

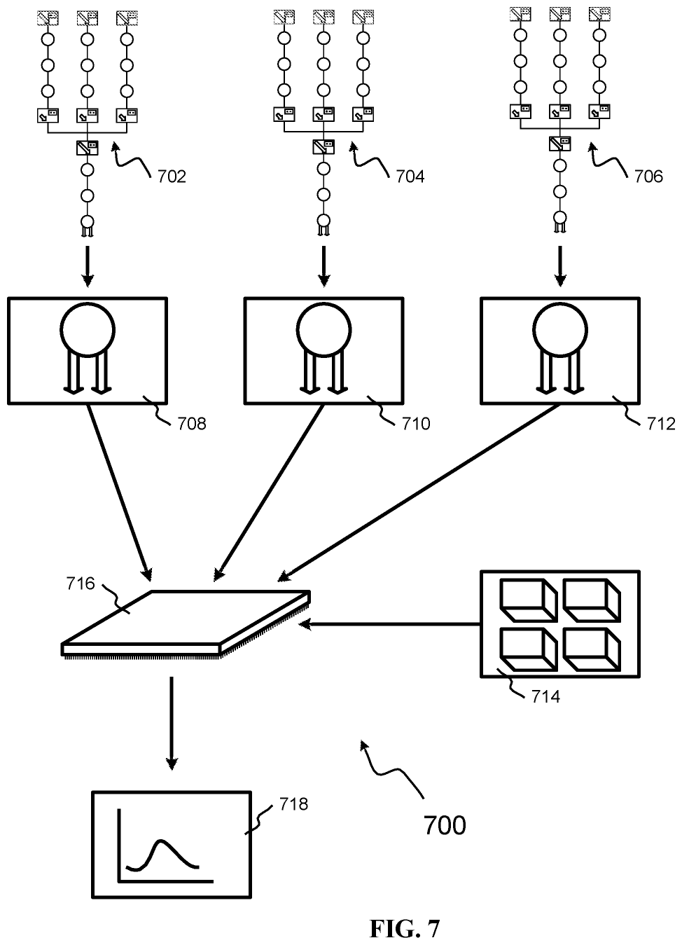

FIG. 7 illustrates a representation of a system 700 that utilizes multiple probability-generation neural networks and structured data to generate a composite projection. For example, system 700 may be beneficial for identifying patterns in data for dynamically assigning a priority to a region of an object. System 700 utilizes neural networks 702, 704, and 706. Neural networks 702, 704, and 706 may be similar to neural network 600, each comprising multiple pathways similar to neural network 500, and utilizing inputs similar to feature vectors 412, 424, and 428 as well as sentiment score(s) 416. At least one of neural networks 702, 704, and 706 may also utilize a sentiment feature vector similar to the sentiment feature vector of input 608.

Feature vectors may be input into the second pathways of neural networks 702, 704, and 706. The sentiment scores associated with the concepts in the list of concepts may also be determined and input into the second pathways of neural networks 702, 704, and 706 with the concept feature vectors. Relevant keywords may be selected by a neural network based on identified contextual relationships and embedded into keyword feature vectors. A sentiment score may also be determined for each identified keyword. Together, keyword feature vectors and associated sentiment scores may be inputted into the third pattern recognizer pathway in each of neural networks 702, 704, and 706.

In some embodiments, neural networks 702, 704, and 706 may be specialized in predicting the probabilities (e.g., expected values) of different target events. In these embodiments, the lists of entities, keywords, and concepts, that may be relevant to each of neural networks 702, 704, and 706 may differ. For that reason, each of neural networks 702, 704, and 706 may accept different groups of feature vectors.

In some embodiments one or more of neural networks 702, 704, and 706 may specialize in processing at least a fourth vector type. For example, each of neural networks 702, 704, and 706 may comprise a fourth pathway that is specialized in processing a sentiment feature vector.

Neural networks 702, 704, and 706 may output probabilities 708, 710, and 712 respectively. Probabilities 708, 710, and 712 may be any projection of a particular device string or pattern in the data indicates new knowledge. For example, probability 708 may be an indication of a new operating system. Probability 710 may be the probability new manufacturer created a device. Probability 712 may be the probability that a new device is present.

In this illustration of system 700, only three new knowledge detection neural networks have been depicted. However, in some embodiments of system 700 further new knowledge detection neural networks may be utilized. For example, a fourth new knowledge detection neural network may be utilized to determine the projected probability that a new device is connected to a network. In other embodiments fewer than three new knowledge detection neural networks may be utilized, such as embodiments that only project a probability that a device is using a new operating system.

Probabilities 708, 710, and 712 are input, with structured data 714, into processor 716, which is configured to perform a multiple-regression analysis. This multiple-regression analysis may be utilized to develop an overall projection 718, which may be calculated in terms of confidence intervals. For example, processor 716 may be utilized to project knew knowledge in a data set on the projected probabilities 708, 710, and 712 associated with that any similar projections that may be identified in structured data 714. This new knowledge score may be presented in confidence intervals based on the output of the multiple-regression analysis.

While system 700 was discussed in reference to a composite projection associated with enclosed embodiments, system 700 may be used to generate a composite prediction in many other subject matters.

As used herein, the term “neural network” may refer to an aggregate neural network that comprises multiple sub neural networks, or a sub neural network that is part of a larger neural network. Where multiple neural networks are discussed as somehow dependent upon one another (e.g., where one neural network's outputs provides the inputs for another neural network), those neural networks may be part of a larger, aggregate neural network, or they may be part of separate neural networks that are configured to communicate with one another (e.g., over a local network or over the internet).

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A system comprising:
a memory storing program instructions; and
a processor in communication with the memory, the processor being configured to execute the program instructions to perform processes comprising:
receiving a frame;
dividing the frame into objects;
selecting an object from the objects;
dividing the object into regions;
determining a set of attributes for a target region of the regions;
assigning a priority to the target region; and
queuing, based on an assignment of a low priority, the target region to a discount rendering instance.

2. The system of claim 1, wherein the memory stores further program instructions, and wherein the processor is configured to execute the further program instructions to perform the processes further comprising:
using a backup image for the rendering from an analogous region, wherein the rendering of the target region failed.

3. The system of claim 2, wherein the program instructions for queuing comprise further program instructions for:
packaging the target region with a second region for a second user; and
sending the package to a discount rendering service.

4. The system of claim 1, wherein the memory stores further program instructions, and wherein the processor is configured to execute the further program instructions to perform the processes further comprising:
setting, based on a determination that the discount rendering instance failed, the priority to high for a subsequent rendering.

5. The system of claim 1, wherein the attributes are selected from the group consisting of an importance of the target region, a rendering time of a region, a due time for the target region, and a backup region for the target region.

6. The system of claim 5, wherein the memory stores further program instructions, and wherein the processor is configured to execute the further program instructions to perform the processes further comprising:
assigning based a high importance, on a long due time, and a short rendering time, the target region to a discount rendering service.

7. The system of claim 1, wherein the priority depends one or more attributes selected from the group consisting of a distance to the object, sightline of the object, and uniqueness of the object.

8. A method comprising:
receiving a frame;
dividing the frame into objects;
selecting an object from the objects;
dividing the object into regions;
determining a set of attributes for a target region of the regions;
assigning a priority to the target region; and
queuing, based on an assignment of a low priority, the target region to a discount rendering instance.

9. The method of claim 8, wherein the method further comprises:
using a backup image for the rendering from an analogous region, wherein the rendering of the target region failed.

10. The method of claim 9, wherein the queuing further comprises:
packaging the target region with a second region for a second user; and
sending the package to a discount rendering service.

11. The method of claim 8, wherein the method further comprises:
setting, based on a determination that the discount rendering instance failed, the priority to high for a subsequent rendering.

12. The method of claim 8, wherein the attributes are selected from the group consisting of an importance of the target region, a rendering time of a region, a due time for the target region, and a backup region for the target region.

13. The method of claim 12, wherein the method further comprises assigning based a high importance, on a long due time, and a short rendering time, the target region to a discount rendering service.

14. The method of claim 8, wherein the priority depends one or more attributes selected from the group consisting of a distance to the object, sightline of the object, and uniqueness of the object.

15. A computer program product comprising a computer readable storage medium having program instructions embodied therewith, the program instructions executable by a processor to cause the processor to perform a method, the method comprising:
receiving a frame;
dividing the frame into objects;
selecting an object from the objects;
dividing the object into regions;
determining a set of attributes for a target region of the regions;
assigning a priority to the target region; and
queuing, based on an assignment of a low priority, the target region to a discount rendering instance.

16. The computer program product of claim 15, further comprising additional program instructions stored on the computer readable storage medium and configured to cause the processor to perform the method further comprising:
using a backup image for the rendering from an analogous region, wherein the rendering of the target region failed.

17. The computer program product of claim 16, wherein the program instructions for queuing comprise further program instructions for:
packaging the target region with a second region for a second user; and
sending the package to a discount rendering service.

18. The computer program product of claim 15, further comprising additional program instructions stored on the computer readable storage medium and configured to cause the processor to perform the method further comprising:
setting, based on a determination that the discount rendering instance failed, the priority to high for a subsequent rendering.

19. The computer program product of claim 15, wherein the attributes are selected from the group consisting of an importance of the target region, a rendering time of a region, a due time for the target region, and a backup region for the target region.

20. The computer program product of claim 19, further comprising additional program instructions stored on the computer readable storage medium and configured to cause the processor to perform the method further comprising:
assigning based a high importance, on a long due time, and a short rendering time, the target region to a discount rendering service.
